(19) United States
(12) Patent Application Publication
(10) Pub. No.: US 2007/0107658 A1
(43) Pub. Date: May 17, 2007

(54) Liquid applying device, method for applying liquid, method for manufacturing liquid crystal device, and electronic equipment

(75) Inventor: Kazuaki Sakurada, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/650,464

(22) Filed: Jan. 8, 2007

Related U.S. Application Data
(62) Division of application No. 10/852,208, filed on May 25, 2004.

(30) Foreign Application Priority Data
Jun. 18, 2003 (JP) 2003-173248

(51) Int. Cl. B05D 5/12

(52) U.S. Cl. 118/69

(57) ABSTRACT

The invention provides a method for manufacturing a liquid crystal device that is capable of controlling a wetting/spreading of a liquid crystal that is applied on and wets on a substrate. The invention can include a unit for ejecting liquid drops that applies a liquid crystal on a substrate, a multi-stage oven that preheats the substrate on which the liquid crystal is to be applied, and a cooling plate that cools down the substrate on which the liquid crystal has been applied are provided. Further, a first robot arm that automatically transfers the substrate to the unit for ejecting liquid drops from the multi-stage oven and a second robot arm that automatically transfers the substrate to the cooling plate from the unit for ejecting liquid drops can be provided.

This is a Division of application Ser. No. 10/852,208 filed May 25, 2004. The disclosure of the prior application is hereby incorporated by reference herein in its entirety.

### BACKGROUND OF THE INVENTION

1. Field of Invention

The present invention relates to a liquid applying device, a method for applying liquid, a manufacturing method for liquid crystal device, a liquid crystal device, and electric equipment.

2. Description of Related Art

As for a color image display part of electric equipment, such as cellular phone or the like, an electronic optical device, such as a liquid crystal display device or the like, are used. The liquid crystal display is configured a pair of transparent substrates between which a liquid crystal is filled. As the first step of forming the liquid crystal display, a sealant is applied on a peripheral part of a surface of one substrate. In so doing, an opening for liquid crystal injection is formed at a part of the sealant. Next, a spacer is sprayed inside of the sealant, thereby bonding together with the other substrate with the sealant therebetween. Accordingly, a liquid crystal cell is formed in a region is surrounded by a pair of the substrates and the sealant. Then, the liquid crystal cell is subjected to vacuum for deaerating, and subsequently brought back to atmospheric pressure while dipping a liquid crystal injection opening in a liquid crystal contained in a vessel. As a result, the liquid crystal cell is filled with the liquid crystal by a pressure difference between inside and outside of the liquid crystal cell and surface tension.

However, in above-mentioned method for liquid crystal injection, an injection takes extremely long time. Especially, if a large size substrate whose diagonal is more than one meter is employed, it will take more than one day to fill it up with the liquid crystal. Thus, a dropping assembly method that the liquid crystal is applied on the substrate by using a device for ejecting liquid drops, such as an ink jet has been proposed. See, for example, Japanese Unexamined Patent Publication No. 10-221666. This method includes following steps: at the first, a sealant such as a thermosetting resin is applied on a peripheral part of a surface of the one substrate. Then, a predetermined amount of the liquid crystal is dropped inside of the sealant by the device for ejecting liquid drops. Finally, the other substrate is bonded together with the sealant, thereby forming a liquid crystal display.

### SUMMARY OF THE INVENTION

In the dropping assembly method described above, however, it is difficult to control the area where the applied liquid crystal wets thereon and spreads over. If a wetting/spreading speed is fast because of a low viscosity of the applied liquid crystal, the liquid crystal that wetted on and spread over the substrate contacts the sealant that is not cured, thereby raising a possibility of the problem where foreign particles are mixed into the liquid crystal. By this foreign particles mixing, an orientation performance of the liquid crystal is deteriorated and an uneven display occurs. Also, if the wetting/spreading speed is slow because of a high viscosity of the applied liquid crystal, it can raise a possibility of an occurrence of incomplete applying of the liquid crystal. By this incomplete applying, a part of the liquid crystal display is not formed, thereby decreasing a yield rate of the liquid display.

In consideration of the above-mentioned problems, the invention aims to provide a liquid applying device and a method for liquid applying that are capable of controlling the wetting/spreading speed of the liquid applied on the substrate, and also increasing a throughput of the liquid applying processes. In addition, the invention aims to provide a method for manufacturing a liquid crystal display, a liquid crystal display, and electric equipment having an excellent display quality.

A liquid applying device that applies liquid to a substrate according to one aspect of the invention can include an applying part applying the liquid to the substrate, a preheating part preheating the substrate to which the liquid is applied, and a transferring means automatically transferring the substrate to the applying part from the preheating part. By preheating the substrate, temperature of the liquid applied to the substrate can be increased to decrease its viscosity, thereby increasing a wetting/spreading speed of the liquid. Also, by preheating the substrate, it is possible to start a liquid applying without a preparation to increase the temperature of the substrate. Therefore, this makes it possible to increase a throughput of a liquid applying process. In addition, with providing of a transferring device that automatically transfers the substrate, this enables the transferring of the substrate efficiently, thereby increasing the throughput of the liquid applying process.

Also, it is preferable that a heating device for the substrate is provided to the transferring device. In this way, it is possible to prevent the substrate in the transferring from temperature dropping. Thus, it is possible to start the liquid applying without a reheating for the substrate in the applying part, thereby increasing the throughput of the liquid applying process.

Also, it is preferable that the heating device for the substrate is provided to the applying part. In this way, it is possible to prevent the substrate in the applying part from temperature dropping, thereby increasing the wetting/spreading speed of the liquid applied to the substrate.

On the other hand, in a liquid applying device that applies liquid to a substrate according to another aspect of the invention, the liquid applying device includes an applying part applying the liquid to the substrate and a cooling part cooling the liquid that has been applied to the substrate. By cooling down the liquid that has been applied to the substrate, temperature of the liquid is decreased to increase its viscosity, thereby slowing down a wetting/spreading speed of the liquid.

Also, it is preferable that a transferring device that automatically transfers the substrate to the cooling part from the applying part is provided. In this way, it enables the substrate transfer more efficiently, thereby increasing a throughput of a liquid applying process.

Also, it is preferable that a cooling device for the liquid that has been applied to the substrate is provided to the transferring means. In this way, it enables the wetting/spreading speed of the liquid to rapidly slow down, thereby increasing the throughput of the liquid applying process.

Also, the cooling device for the liquid that has been applied to the substrate may be provided to the applying part. In this way, it enables the wetting/spreading speed of the liquid to rapidly slow down, thereby increasing the throughput of the liquid applying process.

On the other hand, a method for applying a liquid to a substrate according to another aspect of the invention can include the following steps of preheating the substrate in a preheating part preheating the substrate, a step of automatically transferring the substrate to an applying part applying the liquid to the substrate from the preheating part, and a step of applying the liquid to the substrate in the applying part. In this way, it is possible to increase a wetting/spreading speed of the liquid. Also it enables a throughput of the liquid applying process more increase.

Also, in a method for applying a liquid to a substrate according to another aspect of the invention, the substrate is cooled down after applying the liquid to the substrate.

On the other hand, in a method for manufacturing a liquid crystal device that includes a pair of substrates, a sealant formed between a peripheral part of each of the substrates, and a liquid crystal filled in a space formed by the pair of substrates and the sealant according to another aspect of the invention. The method can include a step of applying the liquid crystal to one substrate of the pair of substrates and a step of cooling the liquid crystal applied to the one substrate. In this construction, it enables a wetting/spreading speed of the liquid crystal more increase and also enables a throughput of a liquid crystal applying process more increase.

Also, it is preferable that the sealant is applied to another substrate of the pair of substrates and bonded together with the one substrate to which the liquid crystal is applied. In this way, since the one substrate to which the liquid is not applied is preheated, there is no possibility that the sealant is heated and cured before the bonding of the both substrates. Thus, it avoids an occurrence of a bonding defect of the substrates.

On the other hand, in a method for manufacturing a liquid crystal device that includes a pair of substrates, a sealant formed between a peripheral part of each of the substrates, and a liquid crystal filled in a space formed by the pair of substrates and the sealant according to another aspect of the invention, the method includes a step of applying the liquid crystal to one substrate of the pair of substrates and a step of cooling the liquid crystal applied to the one substrate. In this way, it enables a wetting/spreading speed of the liquid crystal to slow down.

Also, it is preferable that the cooling for the liquid that has been applied to the one substrate starts before the time when the liquid crystal that has been applied to the one substrate wets thereon and spreads to a position where the liquid crystal contacts the sealant. In this way, the liquid crystal that has been applied to the substrate does not wet on it and spread over beyond a bonding position defined by the sealant. Therefore, this eliminates an occurrence of an incomplete applying due to a shortage of the liquid crystal in a liquid crystal cell and the bonding defect of the substrates. In addition, there is no possibility that foreign particles are mixed into the liquid crystal by touching of the liquid crystal to the sealant.

On the other hand, in a liquid crystal device according to another aspect of the invention, the liquid crystal device can be produced by the method for manufacturing a liquid crystal device as above-mentioned. In this way, it eliminates an occurrence of a mixing of foreign particles into the liquid crystal and an incomplete liquid crystal applying on the substrate, thereby enabling to provide a liquid crystal device having excellent display quality.

On the other hand, electric equipment according to another aspect of the invention includes the liquid crystal device as described above. In this way, electric equipment having an excellent display quality can be provided.

### BRIEF DESCRIPTION OF THE DRAWINGS

The invention will be described with reference to the accompanying drawings, wherein like numerals reference like elements, and wherein:

FIG. 1 is an exemplary block diagram of a unit for ejecting liquid drops;

FIG. 2 is a plan view illustrating a liquid crystal device after removal of a color filter substrate;

FIG. 3 is a longitudinal sectional view of the liquid crystal device taken along line H-H′ in FIG. 2;

FIG. 4 is a rough perspective view of the unit for ejecting liquid drops;

FIG. 5 is a diagram describing an exemplary of a construction of an ink jet head;

FIG. 6 is a rough diagram illustrating a drive voltage waveform of a piezoelectric element and movements of the ink jet head in accordance with the drive voltage;

FIG. 7 is a diagram to describe an exemplary method for manufacturing a liquid crystal device of an embodiment of the invention; and

FIG. 8 is a perspective view of a cellular phone.

### DETAILED DESCRIPTION OF PREFERRED EMBODIMENTS

Embodiments of the invention will now be described with reference to the accompanying drawings. Here, in the accompanying drawings for explanations from onwards, a scale of each element varies so as to change the element size for better comprehension. While a liquid crystal device and a manufacturing method thereof will be described by applying the liquid crystal as the liquid for example hereafter, this invention can be applicable for the case where a liquid excluding the liquid crystal is applied.

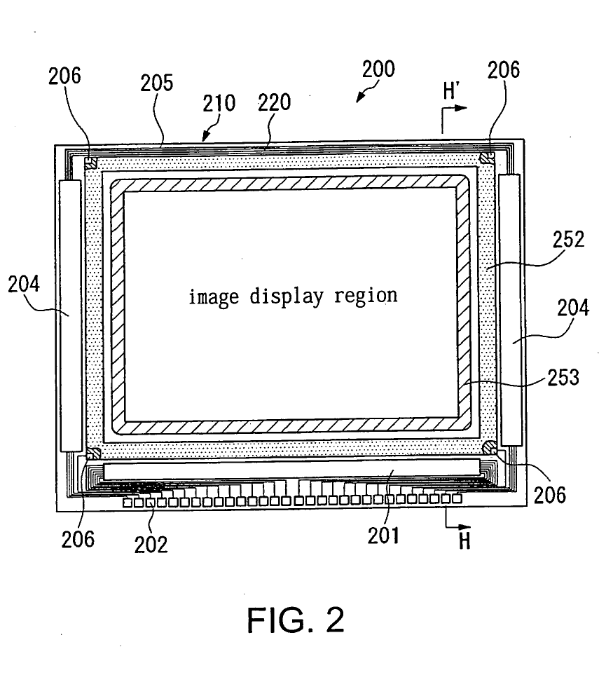

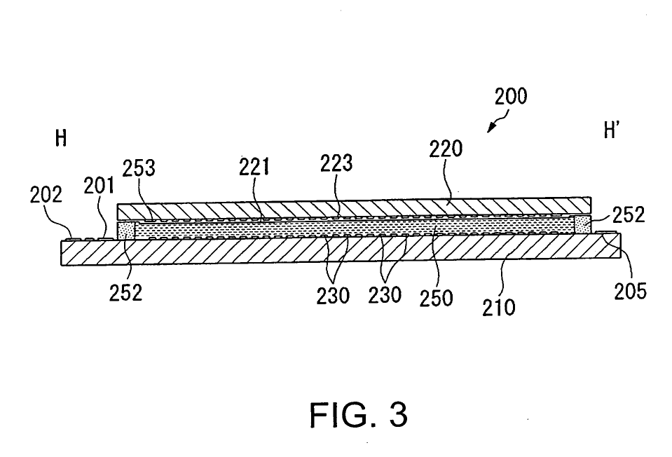

FIG. 2 is a plan view illustrating a liquid crystal device after removal of a color filter substrate. FIG. 3 is a longitudinal sectional view of the liquid crystal device taken along line H-H′ in FIG. 2. While FIG. 2 is the plan view illustrating the liquid crystal device after removal of the color filter substrate, FIG. 3 illustrates the longitudinal sectional view of the whole liquid crystal device including the color filter substrate. In a liquid crystal device 200, a space that is formed by a thin film transistor (TFT) array substrate 210, a color filter substrate 220, and a sealant 252 is filled with a liquid crystal 250, thereby forming a plurality of pixels.

As for the TFT array substrate 210 shown in FIG. 2, a TFT is formed on a surface of a substrate such as a glass or the like so as to be a switching element for each pixel. A plurality of scanning lines (not shown) are provided and extended in parallel from each TFT (not shown). An interlayer insulating film, on which a plurality of data lines (not shown) is formed in parallel, is formed above the each TFT. A source of the each TFT is coupled with the each data line via a through hole. Each of the scanning lines and each of the data lines are crossed perpendicular each other, thereby provided in a matrix. Each of the scanning lines is coupled with a scanning line drive circuit 204 formed on a peripheral part of the substrate. Each of the data lines is coupled with a data line drive circuit 201 formed on the peripheral part of the substrate. Also, a terminal 202 that couples the scanning line drive circuit 204 and the data line drive circuit 201 with an outer part is formed on the peripheral part of the substrate. In addition, the interlayer insulating film, on which pixel electrodes (not shown) are formed, is formed above the data lines. A drain of the each TFT is coupled with the each of the pixel electrodes. An orientation film of the liquid crystal is formed above the pixel electrodes.

On the other hand, in the color filter substrate 220 shown in FIG. 3, color filter layers 223 for each color of red, green, blue (RGB) is formed on the substrate such as the glass. A black matrix is formed in a gap among the color filter layers 223 as a frame like. A protection film, on which a common electrode 221 made of ITO or the like is formed on a surface of the color filter layers. An orientation film for liquid crystal molecules is formed above the common electrode 221. The TFT array substrate 210 and the orientation film of the color filter substrate 220 are made of a thin film, such as polyimide or the like. The surface of the orientation film is rubbed by rubbing a predetermined direction with a roll made of nylon or the like. This rubbing defines the orientation of the liquid crystal for the predetermined direction. It is also possible to define the orientation by forming a plurality of elongated protrusions or the like on a surface of the orientation film instead of the rubbing. The defined orientation direction in the orientation film of the TFT array substrate 210 makes a predetermined angle with respect to the defined orientation direction in the orientation film of the color filter substrate 220.

As shown in FIG. 2, a sealant 252 made of a thermosetting resin that is not cured or the like is applied on a peripheral part of an image display region of the TFT array substrate 210. The sealant 252 is applied and formed along the entire peripheral part of the TFT array substrate 210. At the corner of the sealant 252, a conductive element 206 is formed so as to wire the common electrode of the color filter substrate to the TFT array substrate 210. Also, as shown in FIG. 3, a liquid crystal 250 is applied inside region of the sealant 252 in the color filter substrate 220 by an applying method that will be described in greater detail below. The TFT array substrate 210 and the color filter substrate 220 are bonded together with the sealant 252. This allows the liquid crystal to inject into a space that is formed by the TFT array substrate 210, the color filter substrate 220, and the sealant 252. In addition, a polarizing film (not shown) is provided on an outer surface of the TFT array substrate 210 and the color filter substrate 220. As described above, the liquid crystal device 200 is constructed. In the image display region of the liquid crystal device, a plurality of pixels are provided in a matrix.

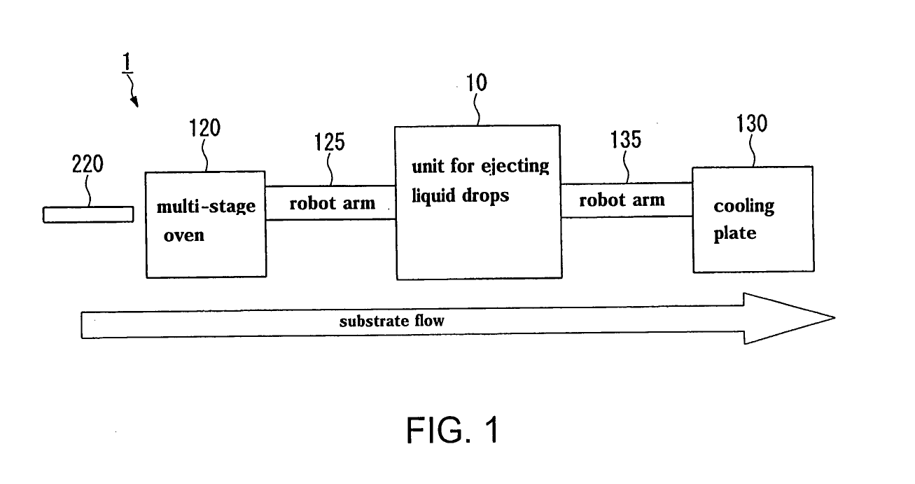

FIG. 1 shows an exemplary block diagram of a unit for ejecting liquid drops in an embodiment of the invention. A unit for ejecting liquid drops 1 that is one of the manufacturing devices of the liquid crystal device is principally constructed by parts as follows: an applying part (a unit for ejecting liquid drops 10) that applies the liquid crystal to the color filter substrate 220 (is called a substrate hereafter), a preheating part (a multi-stage oven 120) that preheats the substrate 220 on which the liquid crystal is not applied, and a cooling part (a cooling plate 130) that cools down the substrate 220 on which the liquid crystal has been applied.

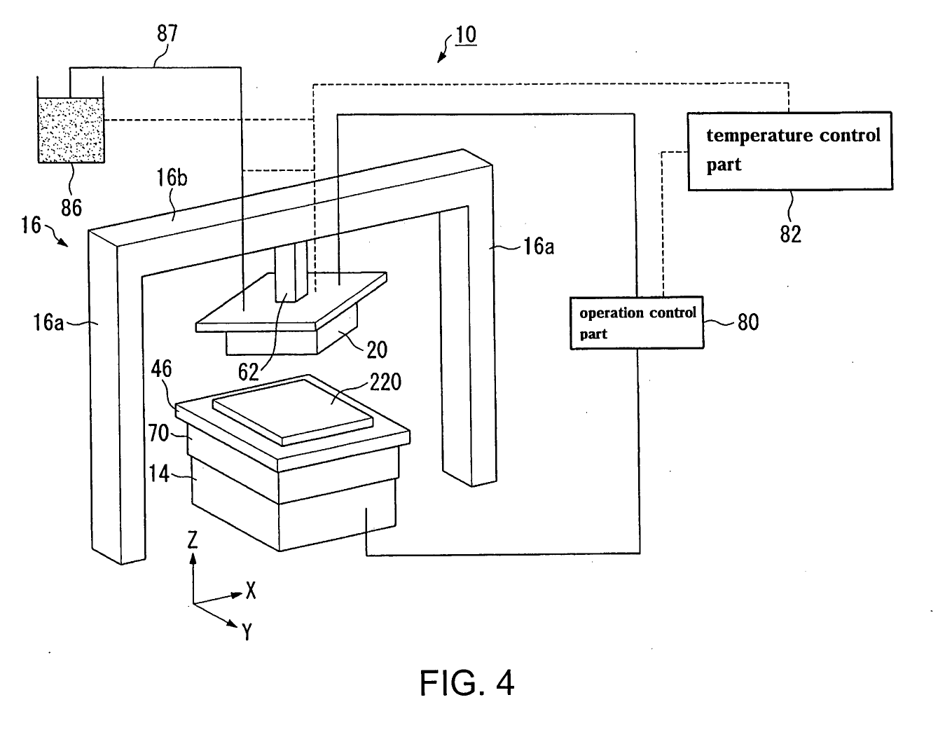

FIG. 4 shows a rough perspective view of the unit for ejecting liquid drops 10 constructing the applying part. The unit for ejecting liquid drops 10 is principally constructed a ink jet head 20 (simply described a head) that ejects the liquid crystal, a head transferring device 16, a stage 46 so as to place the substrate 220, and a stage transferring device 14.

The head transferring device 16 is constructed of two supporting poles 16a that stand in a predetermined distance and a column 16b that is mounted on the two supporting poles. Below a lower surface of the column 16b, a guide rail (not shown) extending for the direction X shown in FIG. 4 and a slider (not shown) that is capable of transferring along the guide rail or the like are disposed. For the examples of a drive for the slider described above, a linear motor or the like are employed. This enables the head 20 disposed below the slider to move along the direction X and also to stop at any position. On the other hand, a linear motor 62 or the like are fixed on the slider mentioned above, this enables a rod (not shown) to move the direction Z shown in FIG. 4 by the linear motor 62. In addition, the head 20 is fixed on an end of the rod, thereby enabling the head 20 to move along the direction Z and to stop at any position. Further, It is possible to rotate the head 20 around a X, Y, and Z-axis and to stop it at any position by coupling the head 20 with another motor or the like.

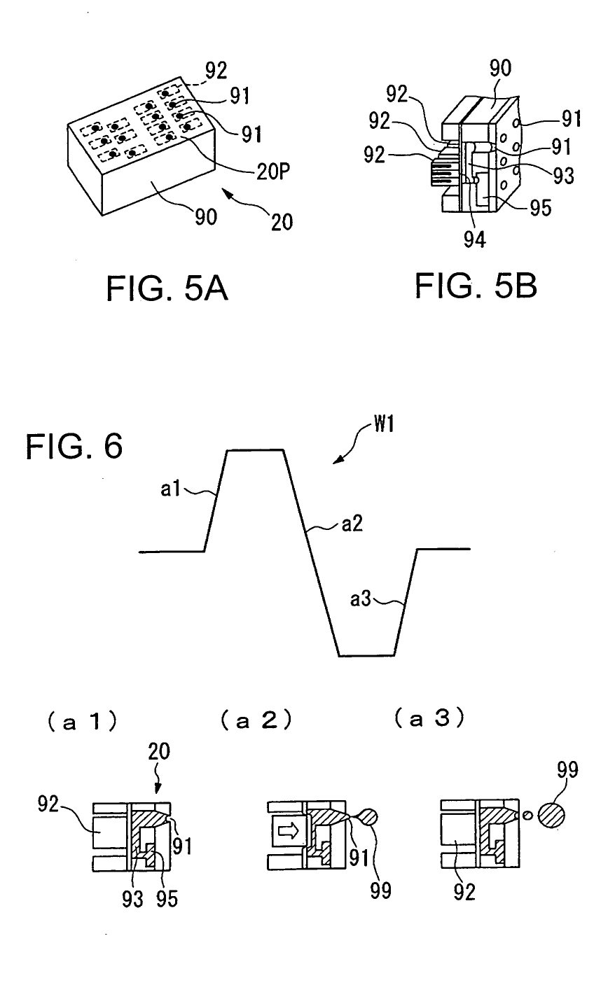

An example of construction of the head 20 will now be described with reference to FIG. 5. In a head body 90 of the head 20, a reservoir 95 and a plurality of ink chambers 93 (a pressure generating chamber) are formed. The reservoir 95 takes a role of a passage so as to supply ink such as the liquid crystal or the like to each of the ink chambers 93. On one end of the head body 90, a nozzle plate that forms an ink ejecting surface 20P is attached. In the nozzle plate, a plurality of nozzles 91 are opened so as to eject the ink in accordance with each of the ink chambers 93. A passage is formed from each of the ink chambers 93 to each of the nozzles 91 correspondingly. On the other end of the head body 90, a vibrating plate 94 is incorporated.

The vibrating plate 94 makes up a wall of the ink chambers 93. On an outside of the vibrating plate 94, a piezoelectric element 92 (a pressure generating device) can be disposed in accordance with each of the ink chambers 93. The piezoelectric element 92 is configured such that a pair of electrodes (not shown) sandwich a piezoelectric material, such as a quartz crystal.

FIG. 6 is a rough diagram illustrating a drive voltage waveform of a piezoelectric element W1 and movements of the head 20 in accordance with the drive voltage. In case where the drive voltage having the waveform W1 is applied to a pair of electrodes that construct the piezoelectric element 92 will now be described as below. In a positive slope part, namely a1 and a3, the piezoelectric element 92 is deformed so as to increase a volume of a corresponding one of the ink chambers 93, thereby causing a flow of ink into the corresponding one of the ink chambers 93 from the reservoir 95. In a negative slope part a2, the piezoelectric element 92 is deformed so as to reduce the volume of the corresponding one of the ink chambers 93, thereby causing an injection of pressured ink 99 from a corresponding one of the nozzles 91. An amplitude and a number of apply voltage of the drive voltage wave form W1 determine an applying amount of ink.

As for a method for driving the head 20, it is not limited to employ a piezojet type using the piezoelectric element 92. For example, a thermal ink jet type utilizing a thermal expansion may be employed. Also, for a method for applying the liquid crystal, another applying method excluding the ink jet head can be used. For example, a dispenser may be employed for the method for applying the liquid crystal instead of the ink jet head. The dispenser can eject the liquid crystal that has high viscosity because it has a larger diameter nozzle than that of the ink jet.

In the unit for ejecting liquid drops 10 shown in FIG. 4, the stage transferring device 14 can be constructed with a guide rail (not shown) extending to the direction Y and a slider (not shown) that is capable of transferring along the guide rail or the like. For the examples of a drive for the slider, the linear motor or the like are employed. This enables a stage 46 disposed above the slider to move along the direction Y and also to stop at any position. In addition, it is possible to rotate the stage 46 around the Z-axis and to stop at any position by coupling the head 20 with another motor or the like. In order to enhance the wetting/spreading performance of the applied liquid crystal, a vibration imparting means 70 to the stage 46 may be incorporated. In this case, the vibration imparting means 70 is mounted to the stage transferring means 14, and then the stage 46 is mounted to the vibration imparting means 70. On an upper surface of the stage 46, a suction holding device for the substrate 220 (not shown) is disposed.

In the unit for ejecting liquid drops 10 shown in FIG. 4, an operation control part 80 is disposed. The operation control part 80 can transfer the head 20 to a predetermined position by applying an operation signal to the head transferring device 16 and the linear motor 62.

Also, by applying a drive signal to the piezoelectric element of the head 20, the operation control part 80 enables the head 20 to eject a predetermined amount of liquid crystal at predetermined timing from the head 20. On the other hand, the operation control part 80 can transfer the stage 46 to a predetermined position by applying an operation signal to the stage transferring device 14. If the vibration imparting device 70 is incorporated, the operation control part 80 can vibrate the stage 46 in a predetermined direction by applying a drive signal to the vibration imparting device 70.

In order to adjust temperature of ink, such as liquid crystal or the like, a temperature adjusting device, such as a heater or the like (not shown), and a temperature sensor (not shown) are attached. The temperature adjusting device and the temperature sensor can also be attached to a ink tank 86 and a ink passage 87 because the ink is supplied to the head 20 through the ink passage 87 from the ink tank 86. In addition, the temperature adjusting device, such as the heater or a cooler or the like, and the temperature sensor can be attached to the stage 46 on which the substrate 220 is placed. The unit for ejecting liquid drops 10 is equipped with a temperature control part 82. This is capable of adjusting the ink a predetermined temperature by controlling the each temperature adjusting device, while monitoring a measuring result from the each temperature sensor. Instead of the each temperature adjusting measures described above or with the each temperature adjusting measures described above, a chamber that is capable of controlling its inside temperature may be disposed around the unit for ejecting liquid drops 10.

This chamber may accommodates the whole of the unit for ejecting liquid drops 10 or may accommodate only the stage 46 on which the substrate 220 is placed and the head 20. This chamber is capable of controlling temperature of the liquid crystal before and after the applying as a whole.

On the other hand, in the unit for ejecting liquid drops shown in FIG. 1, a multi-stage oven 120 constructing a preheat part of the substrate 220 is provided in a prior process of the unit for ejecting liquid drops 10. The multi-stage oven is principally constructed with a chamber equipped with a heating device, such as a heater or the like, a plurality of shelves placed an inside of the chamber, a temperature sensor attached the inside of the chamber, and a temperature control part controlling temperature of the inside of the chamber. The inside of the chamber, the plurality of shelves are placed so as to hold the substrates 220 in multiple numbers. This makes it possible to carry out a batch process for the substrates 220 in multiple numbers, thereby increasing a throughput in a liquid crystal applying process. The chamber is structured a large box like so as to accommodate the plurality of shelves. Also, the inside wall of the chamber, the heating means such as the heater or the like is attached so as to enable the substrates in multiple number to be heated uniformly. The temperature control part can keep the inside of the chamber at a predetermined temperature by applying an operation signal for the heating means depending on a measuring result from the temperature sensor. Any device that is capable of preheating the substrate 220 at a predetermined temperature can be employed other than the multi-stage oven 120 described above.

Between the multi-stage oven 120 and the unit for ejecting liquid drops 10, a first robot arm 125 is disposed as a first transferring device for the substrate 220. The first robot arm 125 is principally constructed with a rotation axis, an arm that is capable of rotating around the rotation axis, a vacuum suction device and a heating device that are provided at distal part of the arm, and a control part controlling an operation of the arm or the like. The arm is adapted so as to enable the arm to rotate around the rotation axis from a position of the multi-stage oven 120 to a position of the unit for ejecting liquid drops 10. The vacuum suction device can be adapted so as to hold the substrate 220 by performing the vacuum suction on a backside of the substrate 220 or the like. The heating device can be constructed with the heater that heats the substrate 220 held by the vacuum suction device and a thermal sensor or the like. The control part is adapted to be capable of controlling the arm, the vacuum suction device, and the heating device or the like by applying an operation signal for the drive motor of the arm, the vacuum suction device, and the heating device. Any device that is capable of transferring the substrate to an applying part from the preheating part may be employed as the first transferring device other than the first robot arm described above.

On the other hand, a cooling plate 130 can be provided in a succeeding process of the unit for ejecting liquid drops 10. The cooling plate 130 is principally constructed with plate on which the substrate 220 is placed, a temperature sensor attached on the surface of the plate, a passage for cooling water formed in the plate, and a temperature control part controlling temperature of the surface of the plate. The plate is made of a metal whose thermal conductivity is high or the like. The cooling water is supplied to the passage formed in the plate from an outside pump. The temperature control part is capable of keeping the surface of the plate at a predetermined temperature by changing a flow amount of the cooling water depending on a measuring result of the temperature sensor. Any device that is capable of cooling the substrate at a predetermined temperature can be employed for the cooling part other than the cooling plate 130 described above.

Between the unit for ejecting liquid drops 10 and the cooling plate 130, a second transferring robot arm 135 is disposed as a second transferring means for substrate 220. The second robot arm 135 differs from the first robot arm 125 in that a cooling means is attached instead of the heating means in the first robot arm 125. The other constructions are the same as those of the first robot arm 125. The cooling device can be constructed with a cooler that cools down the substrate 220 held by the vacuum suction device and a temperature sensor or the like. The control part can control this cooling device or the like by applying an operation signal for them. Any device that is capable of transferring the substrate 220 to the cooling part from the applying part can be employed for the second transferring device.

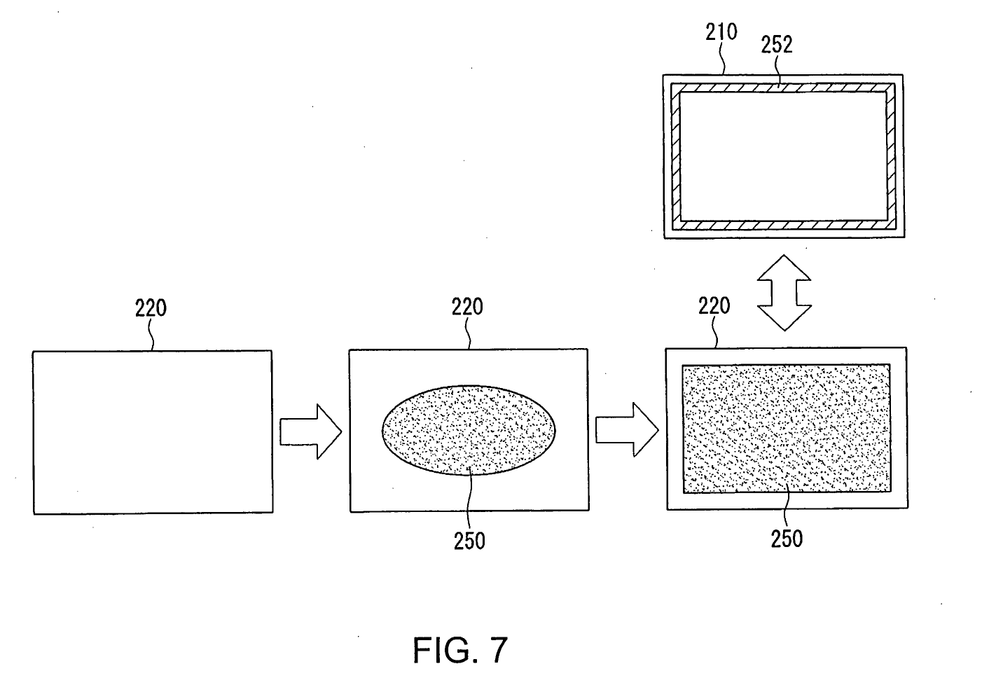

Next, a method for applying the liquid crystal by using the unit for ejecting liquid drops 10 mentioned above will now be described with reference to FIGS. 1, 4, and 7. FIG. 7 is a diagram to describe a method for manufacturing a liquid crystal device of an embodiment of the invention. In this embodiment, a case where the liquid crystal is applied on a color filter substrate 220 and then is bonded together with a TFT array substrate 210 on which a sealant is formed will be described as an example.

As shown in FIG. 1, the substrate 220 is put into the multi-stage oven 220 so as to be subjected to the preheating. The inside temperature of the multi-stage oven 120 is set at seventy degrees, for example. More precisely, if the measuring result by the temperature sensor attached inside the chamber shows below seventy degrees centigrade, a start up signal is applied from the temperature control part so as to start the operation of the heating means such as the heater or the like. If the measuring result by the temperature sensor is above seventy degrees centigrade, a shutdown signal is applied from the temperature control part so as to stop the operation of the heating means such as the heater or the like. Accordingly, the inside temperature of the multi-stage oven can be kept at seventy degrees centigrade.

In the multi-stage oven 120, the substrate 220 is heated at seventy degrees centigrade approximately for ten minutes. A plurality of the substrates may be input into the multi-stage oven 120 at one time or may be sequentially input into it every processing time of the unit for ejecting liquid drops 10. In the later case, if the substrate 220 is taken out in accordance with the order of the input, the preheating time for the each substrate can be uniformed and the substrate 220 can be continuously supplied to the unit for ejecting liquid drops 10. The inside of the multi-stage oven 120, the each substrate 220 is placed on each of the shelves such that each substrate is heated uniformly.

As shown in FIG. 7, in this embodiment, the sealant 252 is applied on the TFT array substrate 210 and the liquid crystal 250 is applied on the color filter substrate 220. Therefore, the color filer substrate 220 is subjected to the preheating. Here, there is no possibility that the sealant 252 is heated and cured before the bonding of the both substrates, because the sealant 252 is not applied on the color filter substrate 220. Consequently, this can avoid an occurrence of the defect in bonding of the both substrates.

Next, the substrate 220 is transferred to the unit for ejecting liquid drops 10 by the first robot arm shown in FIG. 1. More precisely, at first, the arm rotates to a position of the multi-stage oven 120. Then, the vacuum suction device performs the vacuum suction on the backside or the like of the substrate 220 that is to be transferred. Then, the arm that holds the substrate 220 rotates to a position of the unit for ejecting liquid drops 10. Subsequently, the vacuum suction is released above the stage 46 shown in FIG. 4, and then the substrate 220 is placed on the stage 46. This enables the substrate transfer more efficiently, thereby increasing the throughput of the liquid crystal applying process. It is preferable that the substrate is prevented from temperature dropping by heating the substrate with the heating means provided at distal part of the arm during a transferring of the substrate by the arm. Accordingly, a liquid crystal applying can be started immediately without a reheating of the substrate 220 in the unit for ejecting liquid drops 10. Thus, a throughput of a liquid crystal applying process can be increased.

Next, in the unit for ejecting liquid drops 10 shown in FIG. 4, the liquid crystal is applied on the substrate 220. Generally, liquid crystal is high viscosity liquid, which shows a viscosity of fifty centipoises and above at normal temperature (twenty degrees centigrade). Such high viscosity liquid, it is difficult to eject it from a fine diameter nozzle of the head 20. In order to stably eject the liquid crystal from the head 20, the liquid whose viscosity is approximately ten centipoises below is required. Therefore, the temperature control part 82 shown in FIG. 4 operates the temperature adjusting device, such as the heater or the like that is attached to the ink tank 86, the ink passage 87, and the head 20 so as to keep the temperature of the liquid crystal at seventy degrees centigrade. Consequently, this enables the liquid crystal to reduce the viscosity to approximately ten centipoises, thereby enabling the liquid crystal to eject from the head 20. As a result, this makes it possible to eject a predetermined amount of the liquid crystal with accuracy.

On the other hand, the temperature control part 82 operates the temperature adjusting means such as the heater or the like that are attached to the stage 46 so as to keep the temperature of the surface of the stage 46 at approximately seventy degrees centigrade. Accordingly, if the substrate 220 that is preheated is placed on the stage 46, this makes it possible to prevent the substrate 220 from temperature dropping.

Next, the operation control part 80 shown in FIG. 4 applies a operation signal to the stage transferring means and/or the head transferring means 16 so as to place the head 20 above a position from which an applying starts in the substrate 220. Then, the operation control part 80 applies a drive signal to the piezoelectric element in the head 20 so as to eject the liquid crystal to the substrate 220 from the head 20. Subsequently, while transferring the stage 46 and/or the head 20, the liquid crystal is ejected from the head 20. An applying amount per unit area can be controlled by adjusting a relative speed between the head 20 and the stage 46, an ejecting frequency of liquid crystal by the head 20, and a tilt angle of the head 20 with respect to the Z-axis or the like. Consequently, as shown in a center part of FIG. 7, the liquid crystal 250 is applied on a surface of the substrate 220. Particles may be included in the liquid crystal so as to keep a gap between the substrates constant.

As mentioned above, the temperature of the liquid crystal 250 that has been applied on the substrate is kept at approximately seventy degrees centigrade, because the temperature of the substrate 220 is kept at approximately seventy degrees centigrade. Since the viscosity of the liquid crystal 250 becomes low, approximately 10 centipoises at around seventy degrees centigrade, it rapidly wets on and spreads on the substrate as shown in the lower right-hand corner of FIG. 7. In this way, the preheating for the substrate 220 rises the temperature of the liquid crystal that has been applied on the substrate, thereby reducing the viscosity of the liquid crystal. Thus, this makes it possible to increase the wetting/spreading speed of the liquid crystal. Also, since the substrate 220 is preheated, it is possible to start the liquid crystal applying without a preparation to increase the temperature of the substrate in the unit for ejecting liquid drops. Therefore, this makes it possible to increase a throughput of a liquid applying process. In addition, in the unit for ejecting liquid drops, it is possible to prevent the substrate from temperature dropping by preheating for the substrate 220, thereby increasing the wetting/spreading speed of the liquid crystal 250 that has been applied on the substrate. Moreover, heating up the head 20 or the like, which enables the liquid crystal 250 to be ejected and eliminates to increase the temperature of the liquid crystal that has been applied on the substrate. Consequently, this makes it possible to increase the throughput of the liquid crystal applying process.

The color filter substrate 220 on which the liquid crystal 250 is applied is, as described below, bonded together with the TFT array substrate 210 on which the sealant 252 is applied. Thus, if the liquid crystal that has been applied on the color filter array substrate 220 spreads over beyond the bonding area defined by the sealant 252, an incomplete applying due to a shortage of the liquid crystal in a liquid crystal cell and a bonding defect of the two substrates happen. Also, if the liquid crystal 250 touches with the sealant 252, there is a possibility that a resin constituting the sealant 252 mixes into the liquid crystal. Therefore, the liquid crystal 250 that has been applied on the color filter substrate 220 is required to suppress its wetting/spreading before it wets thereon and spreads to a position where the sealant 252 contacts the substrate 220 in the bonding process.

Accordingly, the liquid crystal that has been applied on the substrate 220 is cooled down to approximately forty degrees centigrade. More specifically, the temperature control part 82 shown in FIG. 4 operates the temperature adjusting means such as the cooler such that a measuring result of the temperature sensor attached to the stage 46 shows approximately forty degrees centigrade. This makes it possible to increase a viscosity of the liquid crystal to approximately 25 centipoises, thereby suppressing the wetting/spreading performance. It should be understood that the target temperature of the liquid crystal for cooling down is not limited to forty degrees centigrade. A temperature below seventy degrees centigrade that is the target temperature for heating is acceptable. Alternatively, the substrate 220 on which the liquid crystal has been applied may be transferred to a cooling plate once the liquid crystal is applied, without cooling in the unit for ejecting liquid drops 10. In this case, the stage 46 in the unit for ejecting liquid drops 10 is not required to heat up again to seventy degrees centigrade, thereby preventing the liquid crystal applying process from the yield rate down.

Next, the substrate 220 is transferred to the cooling plate 130 by the second robot arm 135 shown in FIG. 1. A detailed method is the same as the case of the first robot arm. Here, the substrate 220 may be cooled down by the cooling means provided at the distal part of the arm so as to enhance the temperature decreasing of the substrate. This enables the wetting/spreading speed of the liquid crystal to rapidly slow down, thereby increasing the throughput of the liquid crystal applying process.

Then, the substrate 220 is placed on the cooling plate 130. A surface temperature of the cooling plate 130 is set as forty degrees centigrade. More specifically, if a measuring result by the temperature sensor attached on a surface of the cooling plate 130 shows above forty degrees centigrade, the temperature control part applies a start up signal to the outer pump so as to supply the cooling water into the passage formed in the cooling plate 130. If a measuring result by the temperature sensor shows below forty degrees centigrade, the temperature control part applies shutdown signal so as to stop the supply of the cooling water. Alternatively, changing a flow amount of cooling water that is supplying continuously may control the temperature. Consequently, the surface temperature of the cooling plate 130 is kept at forty degrees centigrade.

This cooling plate 130 serves to cool down the substrate 220 to approximately forty degrees centigrade, and also to cool down the liquid crystal that has been applied on the substrate 220 to approximately forty degrees centigrade. This results in an increase of the viscosity of the liquid crystal and a slowing of its wetting/spreading speed. As a result, this makes it possible to suppress the wetting/spreading of the liquid crystal that has been applied on the substrate 220 before the position where it contacts the sealant in the bonding process. Alternatively, by adjusting a start-up time of the cooling down for the substrate 220, it is possible to stop the wetting/spreading of the liquid crystal 250 at a just before the position where the liquid crystal contacts the sealant as shown in the lower right-hand corner of FIG. 7.

Next, the color filter substrate 220 shown in the lower right-hand corner of FIG. 7 and the TFT array substrate 210 shown in the upper right-hand corner of FIG. 7 are bonded together. Prior to this, the sealant 252, such as the thermosetting resin that is not cured or the like, has been applied on a peripheral part of the image display region of the TFT array substrate 210. A screen-printing or a dispenser or the like applies the sealant 252. Particles may be mixed into the liquid crystal so as to keep the gap between the substrates constant.

Then, both substrates are bonded together in vacuum while adjusting the gap between them so as to be constant. Subsequently, both substrates are adhered with the sealant 252 that is cured by the heating at approximately hundred-twenty degrees centigrade for about ten minutes in a heating furnace. As above described, in this embodiment, the wetting/spreading of the liquid crystal 250 that has been applied on the color filter substrate 220 is suppressed before the position where it contacts the sealant 252 applied on the TFT array substrate 210 in the bonding process. Therefore, the liquid crystal 250 does not spread over beyond the bonding area defined by the sealant 252. This eliminates the occurrence of the incomplete applying due to the shortage of the liquid crystal in the liquid crystal cell and the defect of the bonding of the substrates.

A liquid crystal device shown in FIG. 3 is completed.

As described above specifically, with providing of the preheating part that preheats the substrate on which the liquid crystal is to be applied, the wetting/spreading speed of the liquid crystal can be increased. Also, with providing of the cooling part that cools down the liquid crystal that has been applied on the substrate, the wetting/spreading speed of the liquid can be slowed down. In this way, the unit for ejecting liquid drops in this embodiment of the invention can control the wetting/spreading speed of the liquid crystal. In addition, with providing of the temperature adjusting means with the stage of the applying part and the head for ejecting liquid drops, and also with providing of the temperature adjusting means with the transferring device of the substrate, the temperature control of the liquid crystal can be managed promptly.

In this embodiment, the sealant 252 is applied on the TFT array substrate 210, the liquid crystal 250 is applied on the color filter substrate 220, and then both substrates are bonded together. As an opposite way is also acceptable, namely, the sealant 252 is applied on the color filter substrate 220, the liquid crystal 250 is applied on the TFT array substrate 210 and then both substrates are bonded together.

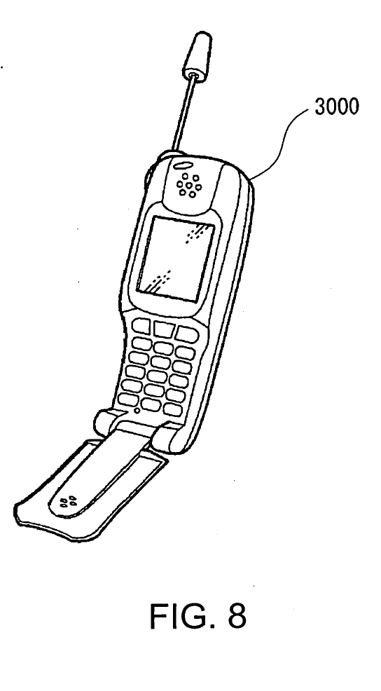

Electric equipment including the liquid crystal device will now be described with reference to FIG. 8. FIG. 8 is a perspective view of a cellular phone. The liquid crystal device that is manufactured as above mentioned can be disposed in casing of a cellular phone 3000.

The liquid crystal device that is manufactured as above mentioned can be applied for various kind of electric equipment as follows: a liquid crystal projector, a multimedia PC (personal computer), an engineering work station (EWS), a pager, a word processor, a television, a viewfinder video tape recorder or a monitor direct view video tape recorder, a personal digital assistant, a desktop electronic calculator, a car navigation device, a point of sales terminal (POS), a device including a touch panel, and the like.

It should be understood that the technical scope of the invention is not limited to the embodiments described above. Various changes, substitutions and alternations can be made therein without departing from spirit and scope of the invention.

What is claimed is:

1. A liquid applying device that applies liquid to a substrate, the liquid applying device comprising:
an applying part that applies the liquid to the substrate; and
a cooling part that cools the liquid that has been applied to the substrate.

2. The liquid applying device according to claim 1, further including a transferring device that automatically transfers the substrate to the cooling part from the applying part.

3. The liquid applying device according to claim 2, a cooling device that cools the liquid that has been applied to the substrate is provided to the transferring device.

4. The liquid applying device according to claim 1, the cooling device that cools the liquid that has been applied to the substrate being provided to the applying part.
